(19) United States
(12) Patent Application Publication
(10) Pub. No.: US 2026/0298476 A1
(43) Pub. Date: Oct. 1, 2026

(54) APPARATUS AND METHOD FOR CONTROLLING COOKING APPLIANCE

(71) Applicant: LG ELECTRONICS INC., Seoul (KR)

(72) Inventors: Hyunwook MOON, Seoul (KR); Jaekyung YANG, Seoul (KR); Dongseong KWAG, Seoul (KR); Myeong Jun SHIN, Seoul (KR)

(73) Assignee: LG ELECTRONICS INC., Seoul (KR)

(21) Appl. No.: 19/544,316

(22) Filed: Feb. 19, 2026

(30) Foreign Application Priority Data
Mar. 26, 2025 (KR) 10-2025-0038667

(51) Int. Cl. F24C 7/08; G06F 3/01

(52) U.S. Cl. CPC F24C 7/083; G06F 3/011

(57) ABSTRACT

Provided is an apparatus for controlling a cooking appliance. The control apparatus generates knock information based on a vibration detection signal resulting from at least two knocks, and matches one of various operations of the cooking appliance with the knock information to set a knock-on function corresponding to the matched operation.

### CROSS-REFERENCE TO RELATED APPLICATION

This application claims priority from Republic of Korea Patent Application No. 10-2025-0038667 filed on Mar. 26, 2025 in the Korean Intellectual Property Office, which is hereby incorporated by reference in its entirety.

### BACKGROUND

### Field

The present disclosure relates to an apparatus and a method for controlling a cooking appliance including a cooktop.

### Description of Related Art

A cooking appliance is one of home appliances for cooking food, and is an apparatus installed in a kitchen space to cook food according to a user's intention. The cooking appliance includes an oven, a microwave, and a cooktop.

A cooktop among the cooking appliances is configured to heat food contained in a cooking container using at least one heating zone. In addition, the cooktop may be implemented alone, or may be implemented in the form of an oven range including an oven under the cooktop.

In the cooktop, on/off, heating intensity, and a timer duration of the heating zone may be adjusted by a user’s manipulation of a knob or button provided on a control panel. For example, the user may select a heating zone to be used by pressing a heating zone selection button provided on the control panel, and may adjust the heating intensity by pressing a heating intensity adjustment button.

Usually, the cooktop is used during a cooking process. Therefore, it is often necessary for the user to manipulate the control panel in a state in which food residue is present on the user's hand. At this time, the control panel may be contaminated with the food residue on the hand, which may cause a manipulation failure.

In this regard, Korean Patent No. 10-2656247 (2024.04.09) is disclosed as a prior art. According to the prior art, when the user knocks on a home appliance, the knock is detected such that a lamp installed inside an accommodation space is turned on, so that the user positioned out of the home appliance may see the inside of the accommodation space through a see-through window.

[Prior Art Literature] [Patent Document] Document 1: Korean Patent No. 10-2656247 (2024.04.09)

### SUMMARY

A technical purpose of the present disclosure is to provide an apparatus and a method for controlling a cooking appliance, which may generate knock information to control an operation of a cooking appliance using a knock and set an operation of the cooking appliance to be controlled using the knock in the knock information.

Further, a technical purpose of the present disclosure is to provide an apparatus and a method for controlling a cooking appliance capable of setting various operations of the cooking appliance to be controlled using the knock in the knock information.

Further, a technical purpose of the present disclosure is to provide an apparatus and a method for controlling a cooking appliance capable of setting the knock information in a user-specific manner.

The purposes of the present disclosure are not limited to the above-mentioned purposes, and other purposes and advantages of the present disclosure that are not mentioned may be understood based on the following descriptions, and will be more clearly understood based on the embodiments of the present disclosure. In addition, it will be readily appreciated that the purposes and advantages of the present disclosure may be realized by means indicated in the claims and combinations thereof.

According to the present disclosure, an apparatus and a method for controlling a cooking appliance may generate knock information to control an operation of a cooking appliance using a knock and set an operation of the cooking appliance to be controlled using the knock in the knock information. Specifically, the control apparatus of the cooking appliance may include a controller configured to: receive a vibration detection signal from a vibration sensor, wherein the vibration detection signal is generated based on vibration resulting from at least two knocks; generate knock information by averaging magnitudes and intervals of the vibration detection signals; and match one of at least one operation of the cooking appliance with the knock information to set a knock-on function corresponding to the matched operation.

The control apparatus of the present disclosure may set various operations of the cooking appliance to be controlled using the knock in the knock information. Specifically, the various operations of the cooking appliance to be controlled using the knock may include an operation of turning on or off power of the cooking appliance, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, and an operation of copying heating zone information.

The control apparatus of the present disclosure may generate the knock information in a user-specific manner. Specifically, the control apparatus of the cooking appliance may generate the knock information in a user-specific manner to obtain user-specific knock information; store the user-specific knock information in a memory; and individually match one of the at least one operation of the cooking appliance with the user-specific knock information to set the knock-on function corresponding to the matched operation.

As described above, the control apparatus and the control method of the present disclosure may generate the knock information based on the vibration detection signal resulting from at least two knocks and match one of the various operations of the cooking appliance with the knock information to set the knock-on function corresponding to the matched operation.

In addition, the control apparatus and the control method of the present disclosure may match, with the knock information, one of an operation of turning on or off power of the cooking appliance, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, and an operation of copying heating zone information, thereby setting the knock-on function corresponding to the matched operation.

In addition, the control apparatus and the control method of the present disclosure may set the knock-on function in the user-specific manner.

In addition, the control apparatus and the control method of the present disclosure may control some of the operations of the cooking appliance via the manipulation of the user knocking on the top plate of the cooking appliance while performing the cooking process, thereby improving user convenience.

In addition, the control apparatus and the control method of the present disclosure may facilitate the manipulation of the cooktop by matching the operation of the cooktop frequently used by the user with the knock information.

In addition, according to the present disclosure, the knock-on function may be set for each user, that is, the user-specific knock-on function may be provided, such that the operations of the cooktop set to be controlled using the knock-on function may be various.

In addition, the control apparatus and the control method of the present disclosure may add the various operations of the cooktop so as to be controlled using the knock-on function through the update of the application installed in the terminal such as a smartphone or the cooking appliance.

The effects of the present disclosure are not limited to the effects mentioned above, and other effects not mentioned will be clearly understood by those skilled in the art from the following descriptions.

### BRIEF DESCRIPTION OF DRAWINGS

FIG. 1 is a perspective view illustrating a cooking appliance according to an embodiment of the present disclosure.

FIG. 2 is a plan cross-sectional view showing an internal structure of the cooking appliance illustrated in FIG. 1.

FIG. 3 is a bottom view illustrating an internal structure of the cooking appliance illustrated in FIG. 1.

FIG. 4 is an example diagram of a heating zone and a control panel of a cooking appliance according to an embodiment of the present disclosure.

FIG. 5 is a block diagram of a control apparatus of a cooking appliance according to an embodiment of the present disclosure.

FIG. 6 is an example diagram of a vibration detection signal resulting from a knock input in the cooking appliance according to an embodiment of the present disclosure.

FIG. 7 is a knock-on setting flowchart of a cooking appliance according to an embodiment of the present disclosure.

FIG. 8 is an example of a knock-on setting screen of a cooking appliance according to an embodiment of the present disclosure.

### DETAILED DESCRIPTIONS

The above-described purposes, features, and advantages will be described in detail with reference to the accompanying drawings, and accordingly, a person having ordinary skill in the art to which the present disclosure pertains will be able to easily implement the technical idea of the present disclosure. In the description of the present disclosure, when it is determined that a detailed description of a known technology related to the present disclosure may unnecessarily obscure the gist of the present disclosure, the detailed description will be omitted. Hereinafter, preferred embodiments according to the present disclosure will be described in detail with reference to the accompanying drawings. In the drawings, the same reference numerals are used to indicate the same or similar components.

Although the first, second, and the like are used to describe various components, it is obvious that these components are not limited by these terms. These terms are used to distinguish only one component from another component. Unless otherwise stated, the first component may be the second component.

The present disclosure is not limited to the embodiments disclosed below, but various changes may be applied thereto and the present disclosure may be implemented in various different forms. However, the present embodiment is provided so that the present disclosure is complete and the scope of the present disclosure is fully informed to those skilled in the art. Therefore, embodiments of the present disclosure are not limited to the embodiments disclosed below, but it should be understood that a configuration of one embodiment and a configuration of another embodiment are substituted with each other or are added to each other, and all changes, equivalents, and substitutes included in the technical spirit and scope of the present disclosure are included in the present disclosure.

The accompanying drawings are only set forth for easy understanding of the embodiments disclosed in the present disclosure, and the technical spirit disclosed in the present disclosure is not limited by the accompanying drawings, and it should be understood that all changes, equivalents, and substitutes included in the spirit and technical scope of the present disclosure are included in the present disclosure. In the drawings, the components may be expressed to be larger or smaller in size or thickness in consideration of convenience of understanding, etc. However, the scope of the present disclosure should not be limited thereto.

The terms used herein are used only to describe specific embodiments or embodiments, and are not intended to limit the present disclosure. As used herein, the singular constitutes "a" and "an" are intended to include the plural constitutes as well, unless the context clearly indicates otherwise In the present disclosure, terms such as "include" and "comprise" are intended to designate that a feature, a number, a step, an operation, a component, a part, or a combination thereof as described in the present disclosure exist. That is, it should be understood that in the present disclosure, the terms such as "include" and "comprise" do not exclude the presence or addition of one or more other features, numbers, steps, operations, components, parts, or combinations thereof.

Terms including ordinals, such as first, second, etc., may be used to describe various components, but the components are not limited by the terms. The terms are used only for the purpose of distinguishing one component from another component.

When it is mentioned that one component is "connected" or "coupled" to another component, it should be understood that one component may be directly connected or coupled to another component, or still another component may be present therebetween. On the other hand, when it is mentioned that one component is "directly connected" or "directly coupled" to another component, it should be understood that still another component is absent therebetween.

When one component is referred to as "being disposed on top of" or "being disposed under" another component, it should be understood that one component may be directly disposed on top of or under another component or still another component may be present therebetween.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A position at which a door is installed in a state in which the cooking appliance is placed on the floor is defined as a front position around a center of the cooking appliance. Therefore, a direction in which a container is inserted into an inner space of the cooking appliance in a state in which the door is defined as a rearward direction. For convenience, a front-rear direction may be referred to as a first direction.

In addition, a horizontal direction orthogonal to the front-rear direction of the cooking appliance, that is, a width direction of the cooking appliance in a state in which the cooking appliance is viewed in front of the door of the cooking appliance may be referred to as a left-right direction. For convenience, the left-right direction may be referred to as a second direction. In addition, the width direction of the cooking appliance may be referred to as a lateral direction. In addition, the width direction of the cooking appliance may be referred to as a longitudinal direction. In this regard, the front-rear direction may be referred to as a transverse direction.

In addition, the direction of gravity may be defined as a downward direction, and the direction opposite to the direction of gravity may be defined as an upward direction. In addition, the up-down direction may be referred to as a third direction. In addition, the above-described up-down direction may be referred to as a vertical direction.

Throughout the present disclosure, "A and/or B" means A, B, or A and B, unless otherwise specified, and "C to D" means being equal to or greater than C and being equal to or smaller than D unless otherwise specified.

Hereinafter, an apparatus and a method for controlling a cooking appliance, which may generate knock information to control an operation of the cooking appliance using a knock and set the operation of the cooking appliance to be controlled using the knock in the knock information.

In the present disclosure, knock information may be defined as at least one reference value and at least one reference period generated based on a magnitude and an interval of a knock detection signal resulting from at least two knocks. In the present disclosure, the knock information may also be referred to as a knock fingerprint.

In the present disclosure, a knock-on function may be defined as an operation of controlling the operation of the cooktop in response to the user's knock.

In the present disclosure, in the knock information (or the knock fingerprint), at least one of an operation of turning on or off cooktop power, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, and an operation of copying heating zone information may be set to correspond to the knock-on function.

### Overall Structure of Cooking Appliance

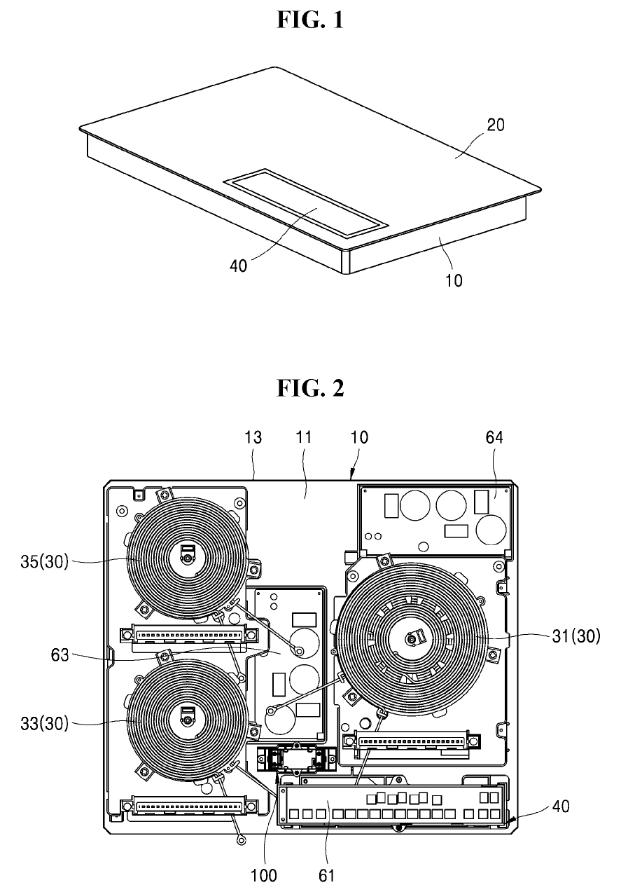

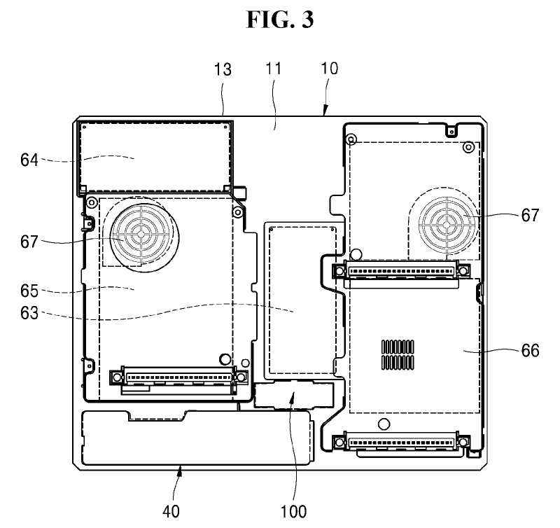

FIG. 1 is a perspective view illustrating a cooking appliance according to an embodiment of the present disclosure. FIG. 2 is a plan cross-sectional view showing an internal structure of the cooking appliance illustrated in FIG. 1. FIG. 3 is a bottom view illustrating an internal structure of the cooking appliance illustrated in FIG. 1.

Referring to FIGS. 1 to 3, the cooking appliance may include a cooktop casing 10 and a top plate 20. According to the present embodiment, an outer shape of the cooking appliance may be defined by the cooktop casing 10 and the top plate 20. The cooktop casing 10 may be disposed under the top plate 20 and may constitute a front surface, a rear surface, a side surface, and a bottom surface of the cooking appliance provided in the form of a cooktop. The top plate 20 may constitute an upper end of the cooking appliance and may define an upper appearance of the cooking appliance.

An accommodation space may be formed inside the cooktop casing 10. The accommodation space formed inside the cooktop casing 10 may be opened upwards. In an example, the cooktop casing 10 may be formed in a hexahedral shape with an open upper side. Various internal components constituting the cooking appliance may be accommodated in the accommodation space defined by the top plate 20 and the cooktop casing 10.

According to the present embodiment, the cooktop casing 10 may include a bottom portion 11. The bottom portion 11 may constitute a bottom surface of the cooktop casing 10 and may define a lower boundary surface of the accommodation space. The bottom portion 11 may be disposed under the top plate 20 and may have a plane parallel to the top plate 20.

In addition, the cooktop casing 10 may include a sidewall portion 13. The sidewall portion 13 may constitute a front surface, a rear surface, and both opposing side surfaces of the cooktop casing 10, and may be formed in a vertical wall shape extending upwards from an edge of the bottom portion 11. The sidewall portion 13 may define a horizontal boundary surface of the accommodation space.

In addition, the cooking appliance may be provided with a heating unit 30 for heating food to be cooked or a container (hereinafter referred to as an "object to be heated or a heating target") containing therein food. At least one heating unit 30 may be provided in the cooking appliance. For example, each heating unit 30 may be provided in a form including a heating coil or a working coil using electricity.

In an example, at least a portion of the heating unit 30 may be disposed in the accommodation space. For example, the heating unit 30 may be disposed in a space surrounded with the cooktop casing 10 and the top plate 20, and may be disposed under the top plate 20. The heating unit 30 may heat the object to be heated or the heating target seated on the top plate 20.

In this embodiment, an example is illustrated in which the cooking appliance is provided in the form of an induction heating cooking appliance. The heating unit 30 of the cooking appliance may be provided in a form including a heating coil. As such, the heating unit 30 including the heating coil may be operated using a high-frequency current applied from an inverter to generate a strong magnetic field line.

As described above, the magnetic field line generated by the heating unit 30 including the heating coil may generate an eddy current in the container. Thus, as the eddy current flows through the container, the heat may be generated to heat the container. As the container is heated, the food contained in the container may be heated.

Various electronic/electrical components may be installed inside the cooking appliance, that is, in the accommodation space. The electronic/electrical components disposed in the accommodation space may include at least one of a main PCB (printed circuit board) 61, a power circuit, and a driving circuit, and may be provided in a form of a circuit board electrically connected to the heating coil of the heating unit 30.

For example, the main PCB may be configured to control the overall operations of the cooking appliance, and may be disposed in a control panel 40. In addition, the power circuit is configured to supply power to the heating coil, and the power circuit may include a switching mode power supply in SMPS), a noise filter (EMI filter) 63, etc. The driving circuit is configured to drive the heating coil, and the driving circuit may include an inverter PCB 65.

In addition, a cooling fan 67 may be disposed inside the cooking appliance. The cooling fan 67 serves to cool the electronic/electrical components by introducing external air into the cooktop casing 10 and supplying the external air to the accommodation space. In an example, the cooling fan 67 may be disposed under the inverter PCB 65, and the cooling fan 67 may effectively cool high heat generation components such as IGBT provided in the inverter PCB 65.

After cooling the electronic/electrical components in the accommodation space, the external air introduced into the cooktop casing 10 under the operation of the cooling fan 67 may be discharged to the outside out of the cooking appliance through an exhaust hole defined in the side surface or the rear surface of the cooktop casing 10. In this embodiment, an example is illustrated in which the exhaust hole is disposed in the rear surface of the cooktop casing 10.

In addition, the cooking appliance of the present embodiment may include the control panel 40. The control panel 40 may be disposed in the top plate 20. The control panel 40 may be provided with a manipulator including various switches for adjusting the operation of the cooking appliance. In addition, the control panel 40 may further include a display for displaying an operating state of the cooking appliance.

In an example, at least a portion of the control panel 40 may be disposed in the accommodation space. For example, the control panel 40 may be disposed in a space surrounded with the cooktop casing 10 and the top plate 20, and may be disposed under the top plate 20. The heating unit 30 may heat the object to be heated or the heating target seated on the top plate 20.

In addition, according to the present embodiment, the control panel 40 may be disposed in front of the heating units 30 provided in the cooking appliance in the plan view. For example, in the front-rear direction, the control panel 40 may be disposed between the frontmost heating unit of the heating units 30 and the front surface of the cooktop casing 10. That is, the control panel 40 may be disposed at a position very adjacent to the front surface of the cooking appliance.

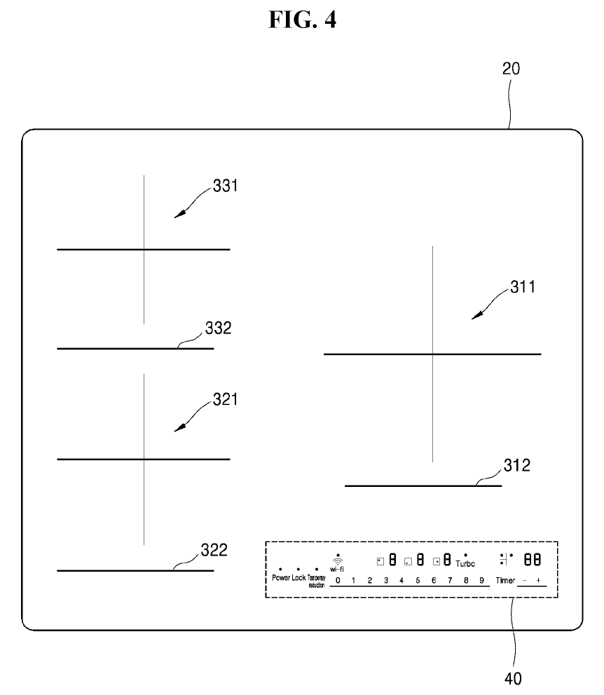

FIG. 4 is an example diagram of a heating zone and a control panel of a cooking appliance according to an embodiment of the present disclosure.

For example, as illustrated in FIG. 4, three heating zones 311, 321, and 331 and the control panel 40 may be disposed in the top plate 20 of the cooking appliance. In addition, indicator lights 312, 322, and 332 respectively indicating a heating-ready state of the three heating zones 311, 321, and 331 may be disposed in the top plate 20.

Buttons for selecting an operation of the cooktop may be disposed in the control panel 40. For example, buttons for turning on the cooktop power, selecting a heating zone to be activated, selecting a heating zone heating intensity (level), setting and releasing a temporary lowering of the heating intensity, setting and releasing a lock, and setting a timer may be disposed in the control panel.

The user may turn on the cooktop power by pressing a button provided in the control panel 40, may select the heating zone to be activated, and may select the heating intensity of the heating zone. In addition, the user may press a button provided in the control panel 40 to temporarily lower the heating intensity of the heating zone or cancel the temporarily lowering thereof, and to lock or unlock the buttons. In addition, the user may set a cooking time duration using the timer.

When the user manipulates the control panel 40 with a hand contaminated with food ingredients or spices, contamination of the control panel 40 may occur, and there is a possibility that a malfunction of the cooking appliance may occur.

Accordingly, embodiments of the present disclosure are directed to providing a cooking appliance capable of controlling various operations of the cooktop using the knock-on function so as to control the operation of the cooktop in a knock manner, and a method for controlling the same. The knock-on function may be defined as a function capable of controlling the various operations of the cooktop based on a vibration detection signal resulting from a user's knock.

### Knock-On Setting of Cooking Appliance

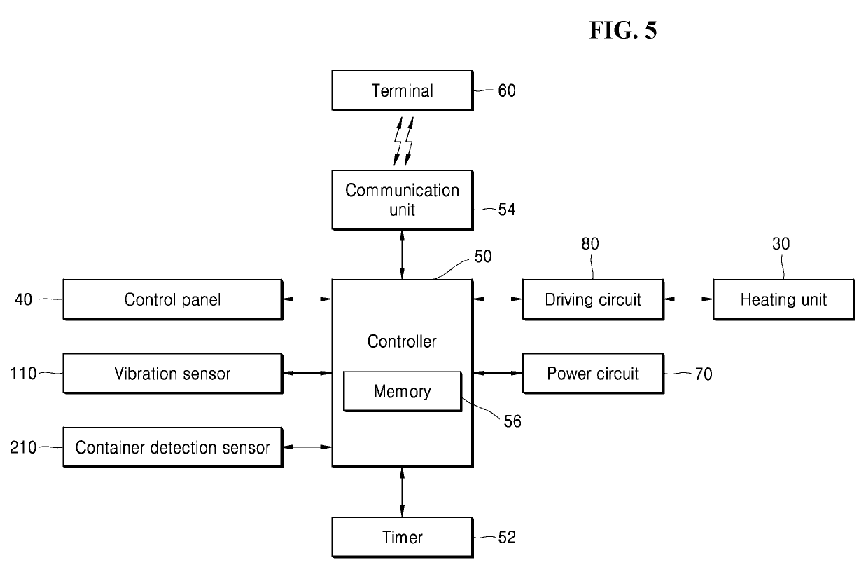

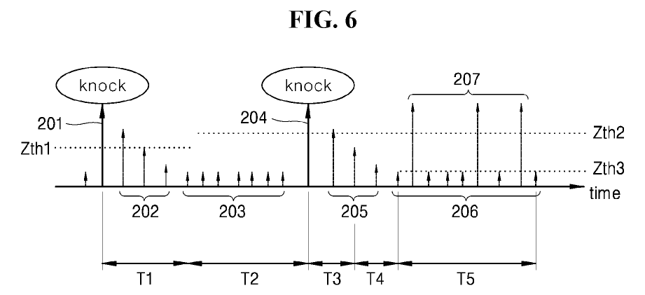

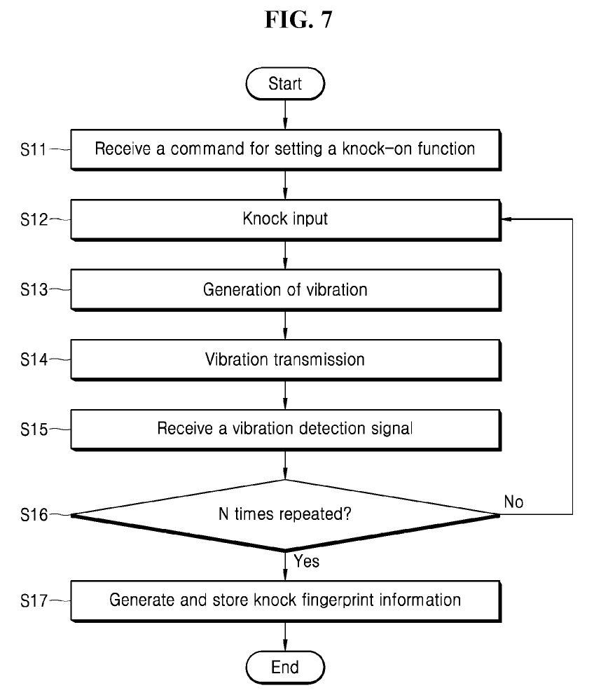

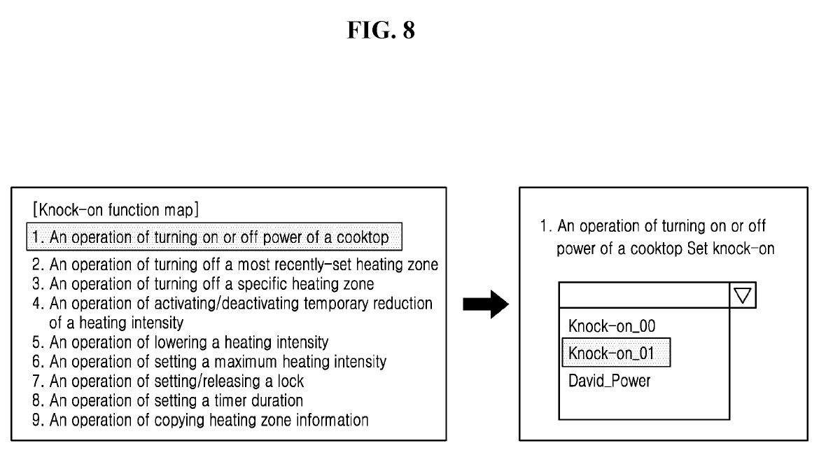

FIG. 5 is a block diagram of a control apparatus of a cooking appliance according to an embodiment of the present disclosure. FIG. 6 is an example diagram of a vibration detection signal resulting from a knock input in the cooking appliance according to an embodiment of the present disclosure. FIG. 7 is a knock-on setting flowchart of a cooking appliance according to an embodiment of the present disclosure. FIG. 8 is an example of a knock-on setting screen of a cooking appliance according to an embodiment of the present disclosure.

Referring to FIGS. 5 to 8, the control apparatus of the cooking appliance according to an embodiment of the present disclosure may include the control panel 40, a vibration sensor 110, a container detection sensor 210, a controller 50, a memory 52, a communication unit 54, a driving circuit 80, a power circuit 70, and the heating unit 30.

The vibration sensor 110 may detect a vibration generated as a result of the user knocking on the top plate 20, and provide a vibration detection signal corresponding to the detected vibration to the controller 50. For example, the vibration sensor 110 may be embodied as one three-axis acceleration sensor that simultaneously senses vibrations transmitted in three-axis directions orthogonal to each other. The three-axis acceleration sensor may detect minute movement changes of the medium due to vibration in the x, y, and z-axis directions orthogonal to each other using a single sensor.

The container detection sensor 210 may detect the cooking container and provide a container detection signal according to the detection to the controller 50. For example, the container detection sensor 210 may store oscillation energy in the detection coil or may generate an oscillation signal which freely resonates, under the control of the controller 50, and compare the oscillation signal with a reference signal, and provide a container detection signal according to the comparison result to the controller 50. The container detection sensor 210 may be disposed in each of a plurality of heating zones.

The communication unit 54 may perform communication between the terminal 60 and the controller 50. An application for setting knock-on may be installed in the terminal 60. The communication unit 54 may communicate with the terminal 60 so that the controller 50 may be configured to interwork with the terminal 60 to set the knock-on function.

The heating unit 30 may include the heating coil corresponding to each of the first to third heating zones, a resonant capacitor, and at least one relay. The heating unit 30 may receive the driving current from the driving circuit 80. The driving current from the driving circuit 80 may be supplied, as resonating AC (alternating current), to the heating coil. The resonance frequency of the alternating current may be determined based on inductance of the heating coil and capacitance of the resonant capacitor.

The driving circuit 80 drives at least one of the heating coils corresponding to the first to third heating zones of the heating unit 30 under the control of the controller 50. For example, the driving circuit 80 may include an inverter circuit. The inverter circuit may supply or block the driving current supply to the heating unit 30 using the switching circuit switched under the control of the controller 50.

The power circuit 70 may supply power to the driving circuit 80 under the control of the controller 50. The power circuit 70 may convert AC power into DC power. For example, the power circuit 70 may include a bridge diode and a DC connection capacitor, may convert an AC voltage into a DC voltage having a constant magnitude and polarity using the bridge diode and the DC connection capacitor, and may convert an AC current having the magnitude and flow direction varying over time into a DC current having the constant magnitude.

The controller 50 may be configured to control at least one of the driving circuit 80 or the power circuit 70 based on a manipulation signal input through the button of the control panel 40. In addition, the controller 50 may be configured to also control a display light displaying an operation state of the cooking appliance. In addition, the controller 50 may be configured to include a timer 56, and may control the driving circuit 80 to drive the heating unit 30 based on a cooking time duration of the heating zone selected using the control panel 40.

The controller 50 may be configured to receive a knock-on setting command from the terminal 60 via the communication unit 54. In setting the knock-on, the controller 50 may be configured to generate knock information based on the magnitude and interval of at least two or more vibration detection signals received from the vibration sensor 110. For example, the controller 50 may be configured to receive the vibration detection signal resulting from a collection of at least two knock inputs which is repeated n times from the vibration sensor 110, and average the magnitudes of the vibration detection signals corresponding to n times of the collections to generate the knock information.

The controller 50 may be configured to define at least one reference value Zth1, Zth2, and Zth3 based on the magnitudes of first and second vibration detection signals 201 and 204 resulting from first and second knocks and define at least one reference period T1, T2, T3, T4, and T5 based on at least one residual vibration signal 202, 203, 205, and 206 resulting from the first and second knocks, thereby generating the knock information.

The controller 50 may be configured to define the first reference value Zth1 based on the magnitude of the first vibration detection signal 201 resulting from the first knock. For example, the controller 50 may be configured to define 50% of the magnitude of the first vibration detection signal 201 as the first reference value Zth1.

In addition, the controller 50 may be configured to define the second reference value Zth2 based on the magnitude of the second vibration detection signal 204 resulting from the second knock. For example, the controller 50 may be configured to define 66% of the magnitude of the second vibration detection signal 204 as the second reference value Zth2.

In addition, the controller 50 may be configured to define the third reference value Zth3 based on the magnitude of the residual vibration signal 206 detected when a predetermined period of time has elapsed after the second knock input. For example, the controller 50 may be configured to define the magnitude of the residual vibration signal 206 detected when a predetermined period T3+T5 has elapsed after the second knock input as the second reference value Zth2.

In this regard, the second reference value Zth2 may be set to a value greater than the first reference value Zth1, and the third reference value Zth3 may be set to a value smaller than the first reference value Zth1.

In addition, the controller 50 may be configured to define at least one reference period T1, T2, T3, T4, and T5 based on at least one residual vibration signal 202, 203, 205, and 206 resulting from the first and second knocks.

For example, the first reference period T1 may be defined as a period for which the value of the first residual vibration signal 202 decreases after the first vibration detection signal 201 resulting from the first knock is detected. In addition, the second reference period T2 may be defined as a period for which the value of the second residual vibration signal 203 is maintained after the first reference period T1 has elapsed.

In addition, a combination of the third reference period T3 and the fourth reference period T4 may be defined as a period for which the value of the third residual vibration signal 205 decreases after the second vibration detection signal 204 resulting from the second knock is detected. In addition, the fifth reference period T5 may be defined as a period for which the value of the fourth residual vibration signal 206 is maintained after the combination of the third reference period T3 and the fourth reference period T4 has elapsed.

As described above, the first reference value Zth1, the second reference value Zth2, the third reference value Zth3, and the at least one reference period T1, T2, T3, T4, and T5 resulting from the first and second knocks may be defined in the knock information, and data on the knock information may be stored in the memory 52.

In addition, the controller 50 may be configured to match one of various operations of the cooktop with the knock information to set the knock-on function. For example, the controller 50 may be configured to match, with the knock information, one of various operations of the cooktop including an operation of turning on or off cooktop power, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, and an operation of copying heating zone information. Thus, the operation matching with the knock information may be set to be controlled using the knock-on function.

A knock-on function map for matching one of the various operations of the cooktop with the knock information may be displayed through the terminal 60. When one of the various operations of the cooktop is selected from the knock-on function map, a menu for storing the knock-on function for each user may be displayed through the terminal 60. In an embodiment of the present disclosure, an example is illustrated in which the knock-on function is guided and set through the terminal 60. However, embodiments of the present disclosure are not limited thereto. In another example, the cooking appliance may include a display device, and may guide and set the knock-on function in conjunction with the display device.

In addition, when the knock-on function setting has been completed, the controller 50 may be configured to control at least one of the power circuit 70 or the driving circuit 80 to control various operations of the cooktop, based on the vibration detection signal detected from the vibration sensor 110.

For example, the controller 50 may be configured to receive the first and second vibration detection signals 201 and 204 resulting from the first and second knocks, compare the first and second vibration detection signals 201 and 204 with the knock information, and determine whether the vibration is caused by the knock onto the top plate 20 or the vibration is not caused by the knock onto the top plate 20, based on the comparison result.

For example, in response to that the first and second vibration detection signals 201 and 204 resulting from the first and second knocks satisfy at least one reference value Zth1, Zth2, and Zth3 and at least one reference period T1, T2, T3, T4, and T5 defined in the knock information, the controller 50 may be configured to determine that the vibration is caused by the knock onto the top plate 20.

In addition, in response to that the vibration detection signal 207 does not satisfy at least one reference value Zth1, Zth2, and Zth3 and at least one reference period T1, T2, T3, T4, and T5 defined in the knock information, the controller 50 may be configured to determine that the vibration detection signal 207 received by the controller 50 does not result from the knock onto the top plate 20.

The controller 50 may be configured to identify the knock information based on the first and second vibration detection signals 201 and 204 resulting from the first and second knocks and to perform the operation of the cooktop matching with the identified knock information.

The operation of the cooking appliance for the knock-on function setting will be described as follows.

First, the cooking appliance may receive a command for setting a knock-on function from the terminal 60 in S11. The cooking appliance may guide the user with a message or voice through the terminal 60 so that the user may knock on the top plate 20 at least twice or more in S12.

When the user performs the knocking at least two times, vibration may be generated in S13. The generated vibration may be transmitted to the vibration sensor 110 of the cooking appliance in S14. At this time, the cooking appliance receives the vibration detection signal resulting from the at least two knock inputs through the vibration sensor 110 in S15. The cooking appliance repeatedly performs the above series of steps n times in S16.

The cooking appliance generates knock fingerprint information based on the average of the vibration detection signals resulting from the repeatedly n times performed series of the steps. Then, when one of various operations of the cooktop is selected by the user, the cooking appliance matches the selected operation with the knock fingerprint information in S17.

As described above, according to the present disclosure, the knock information may be generated based on the vibration detection signal resulting from at least two knock inputs, and one of various operations of the cooktop may be matching the knock information, thereby setting the knock-on function.

In addition, according to the present disclosure, the various operations of the cooktop, including an operation of turning on or off cooktop power, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, and an operation of copying heating zone information may be matching the knock information, thereby setting the knock-on function. Thus, the operation matching with the knock information may be set to be controlled using the knock-on function, that is, to correspond to the knock-on function.

In addition, the control apparatus and the control method of the present disclosure may set the knock-on function for each user, that is, provide a user-specific knock-on function.

In addition, the control apparatus and the control method of the present disclosure may control the operation of the cooktop through the user knocking-on the top plate of the cooktop while the cooking process is performed, thereby improving user convenience.

In addition, the control apparatus and the control method of the present disclosure may facilitate the manipulation of the cooktop by matching the operation of the cooktop frequently used by the user with the knock information.

In addition, according to the present disclosure, the knock-on function may be set for each user, that is, the user-specific knock-on function may be provided, such that the operations of the cooktop set to be controlled using the knock-on function may be various.

In addition, the control apparatus and the control method of the present disclosure may add the various operations of the cooktop so as to be controlled using the knock-on function through the update of the application installed in the terminal such as a smartphone or the cooking appliance.

A first aspect of the present disclosure provides an apparatus for controlling a cooking appliance, the apparatus comprising: a vibration sensor configured to detect vibration resulting from at least two knocks and generate and provide a vibration detection signal corresponding to the detected vibration to a controller; and the controller configured to: receive the vibration detection signal; generate knock information based on a magnitude and an interval of the vibration detection signal; and match one of at least one operation of the cooking appliance with the knock information to set a knock-on function corresponding to the matched operation.

In accordance with some embodiments of the apparatus, the vibration sensor is configured to detect n vibration detection signals resulting from n times repetitions of the at least two knocks, wherein the controller is configured to average the magnitudes and intervals of the n vibration detection signals to generate the knock information.

In accordance with some embodiments of the apparatus, the controller is configured to: define a first reference value based on a magnitude of a first vibration detection signal resulting from a first knock; define a second reference value and a third reference value based on a magnitude of a second vibration detection signal resulting from a second knock; define at least one reference period based on an interval between the first knock and the second knock; and generate the knock information including the first and second reference value and the at least one reference period.

In accordance with some embodiments of the apparatus, the controller is configured to define the third reference value based on a magnitude of a residual vibration signal detected when a predetermined period of time has elapsed after the second knock.

In accordance with some embodiments of the apparatus, the second reference value is set to be greater than the first reference value, and the third reference value is set to be smaller than the first reference value.

In accordance with some embodiments of the apparatus, upon receiving the vibration detection signal from the vibration sensor after the setting of the knock-on function has been completed, the controller is configured to control the operation of the cooking appliance corresponding to the knock-on function.

In accordance with some embodiments of the apparatus, the at least one operation of the cooking appliance includes an operation of turning on or off power of the cooking appliance, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, or an operation of copying heating zone information.

In accordance with some embodiments of the apparatus, the controller is configured to: generate the knock information in a user-specific manner to obtain user-specific knock information; store the user-specific knock information in a memory; and individually match one of the at least one operation of the cooking appliance with the user-specific knock information to set the knock-on function corresponding to the matched operation.

In accordance with some embodiments of the apparatus, the apparatus further comprises a communication unit configured to perform communication between the controller and a terminal, wherein an application for setting the knock-on function is installed in the terminal.

In accordance with some embodiments of the apparatus, the controller is configured to interwork with the terminal such that the terminal displays thereon a guide message for generating the knock information, a guide message for matching one of the at least one operation of the cooking appliance with the knock information, and a guide message for setting the knock-on function in a user-specific manner.

A second aspect of the present disclosure provides a method for controlling a cooking appliance, the method comprising: receiving a vibration detection signal, wherein the vibration detection signal is generated based on vibration resulting from at least two knocks; generating knock information based on a magnitude and an interval of the vibration detection signal; and matching one of at least one operation of the cooking appliance with the knock information to set a knock-on function corresponding to the matched operation.

In accordance with some embodiments of the method, the receiving of the vibration detection signal includes receiving n vibration detection signals resulting from n times repetitions of the at least two knocks, wherein the generating of the knock information includes: averaging the magnitudes and intervals of the n vibration detection signals to obtain an average magnitude and an average interval; and defining at least one reference value and at least one reference period based on the average magnitude and the average interval.

In accordance with some embodiments of the method, the defining of the at least one reference value and the at least one reference period includes: defining a first reference value based on a magnitude of a first vibration detection signal resulting from a first knock; defining a second reference value based on a magnitude of a second vibration detection signal resulting from a second knock; defining a third reference value based on a magnitude of a residual vibration signal detected when a predetermined time duration has elapsed after the second knock; and defining a reference period based on an interval between the first knock and the second knock.

In accordance with some embodiments of the method, the at least one operation of the cooking appliance includes an operation of turning on or off power of the cooking appliance, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, or an operation of copying heating zone information.

In accordance with some embodiments of the method, the generating of the knock information includes generating the knock information in a user-specific manner to obtain user-specific knock information and storing the user-specific knock information in a memory, wherein the matching of one of the at least one operation of the cooking appliance with the knock information includes individually matching one of the at least one operation of the cooking appliance with the user-specific knock information to set the knock-on function corresponding to the matched operation.

In accordance with some embodiments of the method, the method further comprises: upon receiving a command for setting the knock-on function from a terminal, interworking the cooking appliance with the terminal such that the terminal displays thereon a guide message for generating the knock information, a guide message for matching one of the at least one operation of the cooking appliance with the knock information, and a guide message for setting the knock-on function in a user-specific manner.

Although embodiments of the present disclosure have been described with reference to the accompanying drawings, the present disclosure is not limited to the above embodiments, but may be implemented in various different forms. A person skilled in the art may appreciate that the present disclosure may be practiced in other concrete forms without changing the technical spirit or essential characteristics of the present disclosure. Therefore, it should be appreciated that the embodiments as described above are not restrictive but illustrative in all respects.

What is claimed is:

1. An apparatus for controlling a cooking appliance, the apparatus comprising:
a vibration sensor configured to detect vibration resulting from at least two knocks and generate and provide a vibration detection signal corresponding to the detected vibration to a controller; and
the controller configured to:
receive the vibration detection signal;
generate knock information based on a magnitude and an interval of the vibration detection signal; and
match one of at least one operation of the cooking appliance with the knock information to set a knock-on function corresponding to the matched operation.

2. The apparatus of claim 1, wherein the vibration sensor is configured to detect n vibration detection signals resulting from n times repetitions of the at least two knocks,
wherein the controller is configured to average the magnitudes and intervals of the n vibration detection signals to generate the knock information.

3. The apparatus of claim 2, wherein the controller is configured to:
define a first reference value based on a magnitude of a first vibration detection signal resulting from a first knock;
define a second reference value and a third reference value based on a magnitude of a second vibration detection signal resulting from a second knock;
define at least one reference period based on an interval between the first knock and the second knock; and
generate the knock information including the first and second reference value and the at least one reference period.

4. The apparatus of claim 3, wherein the controller is configured to define the third reference value based on a magnitude of a residual vibration signal detected when a predetermined period of time has elapsed after the second knock.

5. The apparatus of claim 4, wherein the second reference value is set to be greater than the first reference value, and the third reference value is set to be smaller than the first reference value.

6. The apparatus of claim 1, wherein upon receiving the vibration detection signal from the vibration sensor after the setting of the knock-on function has been completed, the controller is configured to control the operation of the cooking appliance corresponding to the knock-on function.

7. The apparatus of claim 1, wherein the at least one operation of the cooking appliance includes an operation of turning on or off power of the cooking appliance, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, or an operation of copying heating zone information.

8. The apparatus of claim 7, wherein the controller is configured to:
generate the knock information in a user-specific manner to obtain user-specific knock information;
store the user-specific knock information in a memory; and
individually match one of the at least one operation of the cooking appliance with the user-specific knock information to set the knock-on function corresponding to the matched operation.

9. The apparatus of claim 1, wherein the apparatus further comprises a communication unit configured to perform communication between the controller and a terminal,
wherein an application for setting the knock-on function is installed in the terminal.

10. The apparatus of claim 9, wherein the controller is configured to interwork with the terminal such that the terminal displays thereon a guide message for generating the knock information, a guide message for matching one of the at least one operation of the cooking appliance with the knock information, and a guide message for setting the knock-on function in a user-specific manner.

11. A method for controlling a cooking appliance, the method comprising:
receiving a vibration detection signal, wherein the vibration detection signal is generated based on vibration resulting from at least two knocks;
generating knock information based on a magnitude and an interval of the vibration detection signal; and
matching one of at least one operation of the cooking appliance with the knock information to set a knock-on function corresponding to the matched operation.

12. The method of claim 11, wherein the receiving of the vibration detection signal includes receiving n vibration detection signals resulting from n times repetitions of the at least two knocks,
wherein the generating of the knock information includes:
averaging the magnitudes and intervals of the n vibration detection signals to obtain an average magnitude and an average interval; and
defining at least one reference value and at least one reference period based on the average magnitude and the average interval.

13. The method of claim 12, wherein the defining of the at least one reference value and the at least one reference period includes:
defining a first reference value based on a magnitude of a first vibration detection signal resulting from a first knock;
defining a second reference value based on a magnitude of a second vibration detection signal resulting from a second knock;
defining a third reference value based on a magnitude of a residual vibration signal detected when a predetermined time duration has elapsed after the second knock; and
defining a reference period based on an interval between the first knock and the second knock.

14. The method of claim 13, wherein the second reference value is set to be greater than the first reference value, and the third reference value is set to be smaller than the first reference value.

15. The method of claim 11, wherein the method further comprises:
upon receiving the vibration detection signal from after the setting of the knock-on function has been completed, controlling the operation of the cooking appliance corresponding to the knock-on function.

16. The method of claim 11, wherein the at least one operation of the cooking appliance includes an operation of turning on or off power of the cooking appliance, an operation of turning off a most recently-set heating zone, an operation of turning off a specific heating zone, an operation of activating/deactivating temporary reduction of a heating intensity, an operation of lowering a heating intensity, an operation of setting a maximum heating intensity, an operation of setting/releasing a lock, an operation of setting a timer duration, or an operation of copying heating zone information.

17. The method of claim 16, wherein the generating of the knock information includes generating the knock information in a user-specific manner to obtain user-specific knock information and storing the user-specific knock information in a memory,
wherein the matching of one of the at least one operation of the cooking appliance with the knock information includes individually matching one of the at least one operation of the cooking appliance with the user-specific knock information to set the knock-on function corresponding to the matched operation.

18. The method of claim 11, wherein the method further comprises:
upon receiving a command for setting the knock-on function from a terminal,
interworking the cooking appliance with the terminal such that the terminal displays thereon a guide message for generating the knock information, a guide message for matching one of the at least one operation of the cooking appliance with the knock information, and a guide message for setting the knock-on function in a user-specific manner.
